(19) United States
(12) Patent Application Publication
(10) Pub. No.: US 2002/0148598 A1
(43) Pub. Date: Oct. 17, 2002

(54) Control installation including a sorter for processing solid bodies circulated in a heat exchanger to clean it, and a sorter for use in said control installation

(75) Inventor: Renaud Houel, Montfort L'Amaury (FR)

Correspondence Address: YOUNG & THOMPSON, 745 SOUTH 23RD STREET 2ND FLOOR, ARLINGTON, VA, 22202

(73) Assignee: BEAUDREY C S, COURBEVOIE (FR)

(21) Appl. No.: 10/119,846

(22) Filed: Apr. 11, 2002

(30) Foreign Application Priority Data
Apr. 13, 2001 (FR) 0105131

(51) Int. Cl. B08B 1/00; A47L 3/00; A47L 11/00; D06F 15/00; A47L 23/00; D06F 37/00; D06F 39/00; A47L 13/00; F28F 13/12; F28F 19/00

(52) U.S. Cl. 165/119; 15/3; 15/51

(57) ABSTRACT

A control installation for solid cleaning bodies adapted to be circulated in a heat exchanger to clean it, said installation including interceptor means in the outlet pipe of the heat exchanger adapted to retain the circulating solid cleaning bodies, a return pipe which recycles to the inlet pipe of the heat exchanger a return flow containing solid cleaning bodies retained by the interceptor means, and a system in said return pipe for processing said solid cleaning bodies and including a sorter (30): the sorter (30) includes a body (31), in which there are two compartments (37, 38) separated by a calibrated grid (40), and turbulence generator means (48, 54) adapted to create turbulence in one compartment (38) to attract into it cleaning bodies which can pass through the grid (40) because of their diameter.

The present invention relates generally to heat exchangers, for example tubular heat exchangers forming condensers, which are cleaned continuously by solid bodies, in practice in the form of foam rubber balls, for example, that are systematically circulated for this purpose in one of the flows.

The principles of the corresponding arrangements have been known to the person skilled in the art for a long time, in particular from the document U.S. Pat. No. 1,795,348.

The present invention is more particularly directed to processing the solid cleaning bodies used in this way.

In arrangements of the kind described in the document FR-A-2 716 530, for example, this entails, on the one hand, to prevent the solid cleaning bodies being drained off with the flow that carries them, fitting to the outlet pipe of the heat exchanger interceptor means adapted to retain them, and, on the other hand, recycling the solid cleaning bodies retained in this way by the interceptor means to the inlet pipe of the heat exchanger.

However, in practice, it is also necessary to pass the solid cleaning bodies systematically through a dedicated control unit, in particular for checking their number, sorting them, eliminating those whose dimensions have, through wear, become less than required, and consequential topping up with new solid cleaning bodies.

This is because the cleaning efficiency depends on the diameter of the cleaning bodies in the form of balls, which must be greater than the inside diameter of the tubes to be cleaned; as the person skilled in the art knows, the balls are progressively worn by abrasion and it is necessary to remove from the circuit any worn balls whose diameter is no longer sufficient.

To effect such removal, there has already been proposed a sorting system or sorter in which the cleaning bodies are forced between bars by diverting a portion of the flow at high speed; because of the high speed, and the associated head losses, the balls are compressed, which falsifies the sorting; also, the hardness of the balls is chosen as a function of the type of condenser, the nature of the tubes, the soiling thereof, and other factors; it is therefore difficult to adjust the sorter, and the stability of operation is highly random, variations in the hydraulic conditions in the condenser obviously affecting the cleaning circuit.

An object of the present invention is to propose an installation including a sorter for processing solid bodies circulated in a heat exchanger that avoids measurable compression of the balls and sorts the balls in accordance with a purely geometrical criterion, independently of their hardness and variations in hydraulic conditions.

According to the invention, a control installation for solid cleaning bodies adapted to be circulated in a heat exchanger to clean it, said installation including interceptor means in the outlet pipe of the heat exchanger adapted to retain the circulating solid cleaning bodies, a return pipe which recycles to the inlet pipe of the heat exchanger a return flow containing solid cleaning bodies retained by the interceptor means, and a system in said return pipe for processing said solid cleaning bodies and including a sorter, is characterized in that the sorter includes a body, in which there are two compartments separated by a calibrated grid, and turbulence generator means adapted to create turbulence in one compartment to attract into it cleaning bodies which can pass through the grid because of their diameter.

The installation advantageously includes circulation means which include an inlet pipe downstream of the interceptor means and a pump, the sorter being between the inlet pipe and the aspiration pipe of the pump.

The body of the sorter is preferably in two portions, namely a first portion connected, on one side, to the inlet pipe and, on the other side, to the second portion, which is itself connected to the head of a return Tee also connected to the aspiration pipe of the pump.

The two compartments of the body advantageously comprise a main compartment between the inlet pipe and the head of the return Tee and a recovery compartment in which turbulence is created.

The recovery compartment is preferably connected by a pipe to the leg of the return Tee via a pot to the interior of which the leg of the return Tee is connected via a strainer.

The pot is advantageously connected to the exterior via a drain valve.

In a preferred embodiment of the invention the grid has a fixed portion featuring a series of divergent slots and a mobile mask provided with teeth adapted to cooperate with the slots; the grid is globally parallel to the direction of the flow through the body and the width of the slots is greater on the downstream side than on the upstream side relative to said flow.

In a first embodiment of the invention the turbulence generator means consist of an increase in the section of the flow passage.

The body advantageously includes a large section chamber divided by the grid and preceded by a smaller section area.

In another embodiment of the invention the turbulence generator means consist of an obstacle in the flow passage.

The recovery compartment is preferably bordered on the same side as the inlet pipe by a transverse wall constituting the turbulence generator means; alternatively, the recovery compartment is bordered on the same side as the inlet pipe by a flow deflector constituting the turbulence generator means.

The recovery compartment is preferably bordered on the same side as the return Tee by a partition which connects the main compartment to the head of the return

The present invention also provides a sorter for use in a control installation as defined above.

The sorter advantageously includes two compartments separated by a grid and turbulence generator means.

The turbulence generator means preferably consist of an increase in the section of the flow passage; alternatively, the turbulence generator means consist of an obstacle in the flow passage.

To explain the subject matter of the invention in more detail, an embodiment of the invention shown in the accompanying drawings will now be described by way of purely illustrative and nonlimiting example.

In the drawings:

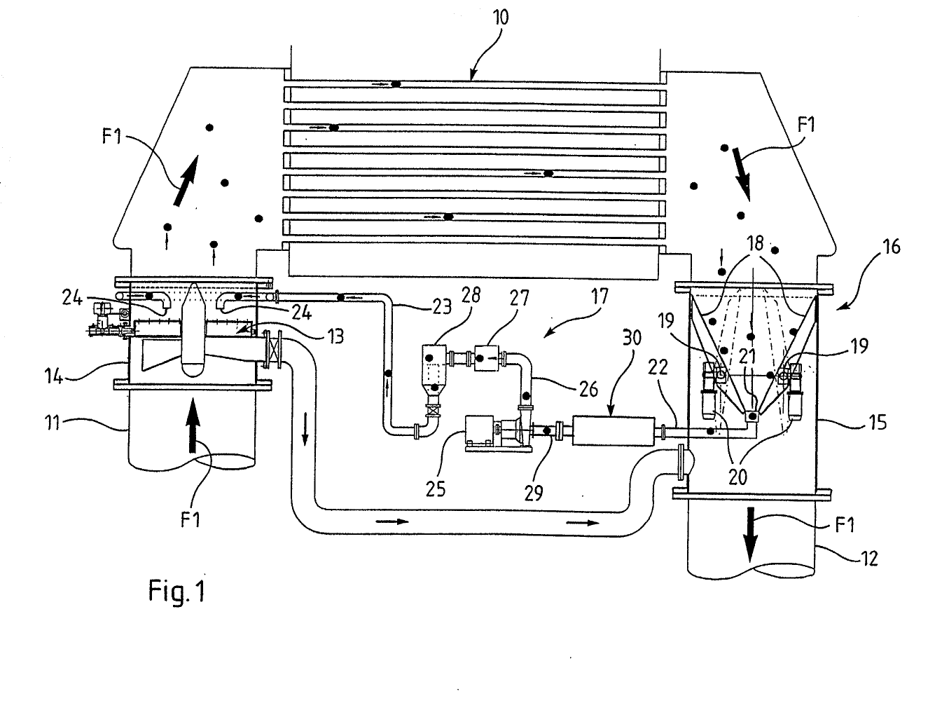

FIG. 1 is a diagram showing part of an installation for processing solid bodies circulating in a heat exchanger to clean it, the installation including a sorter according to the invention;

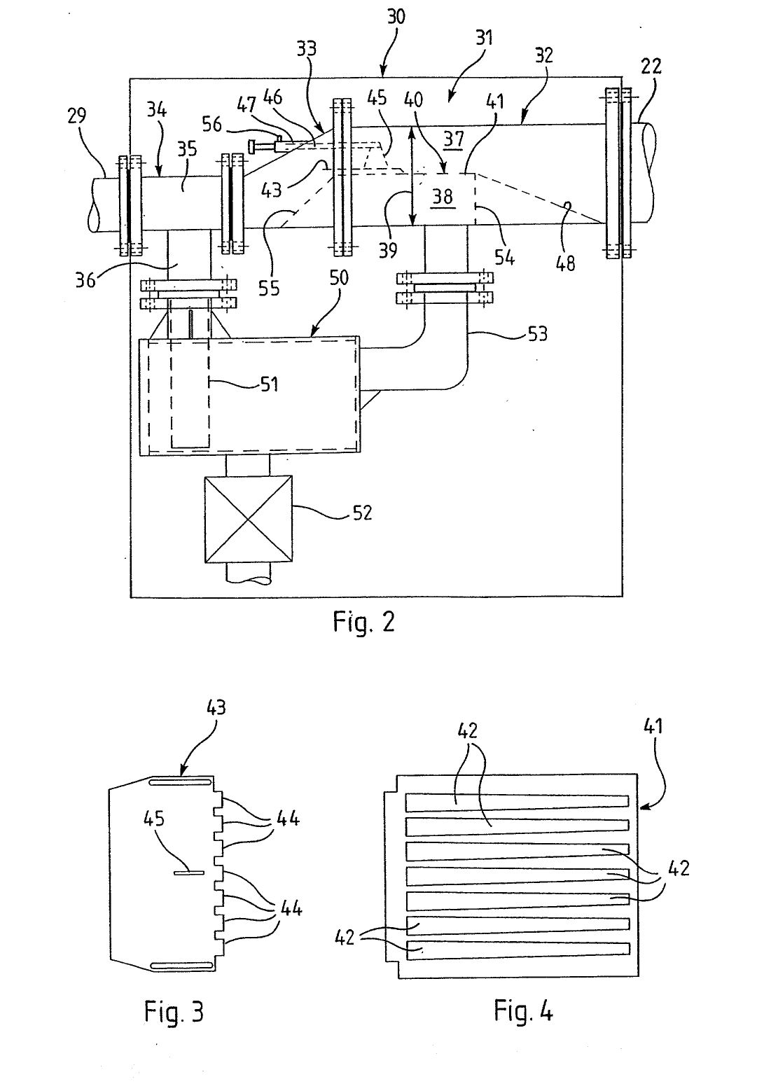

FIG. 2 is a diagrammatic view of the sorter from FIG. 1;

FIG. 3 is a plan view of a grid adjustment mobile mask shown in FIG. 2;

FIG. 4 is a plan view of the fixed portion of the grid shown in FIG. 2, which has divergent slots;

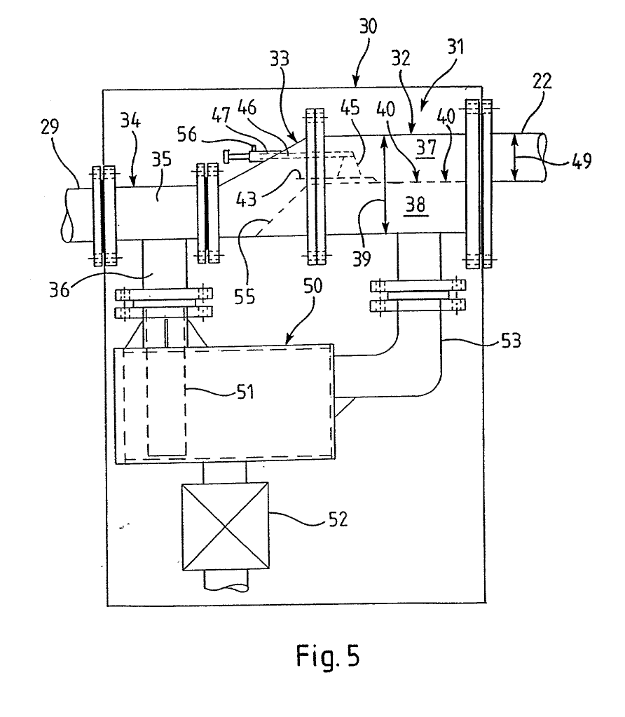

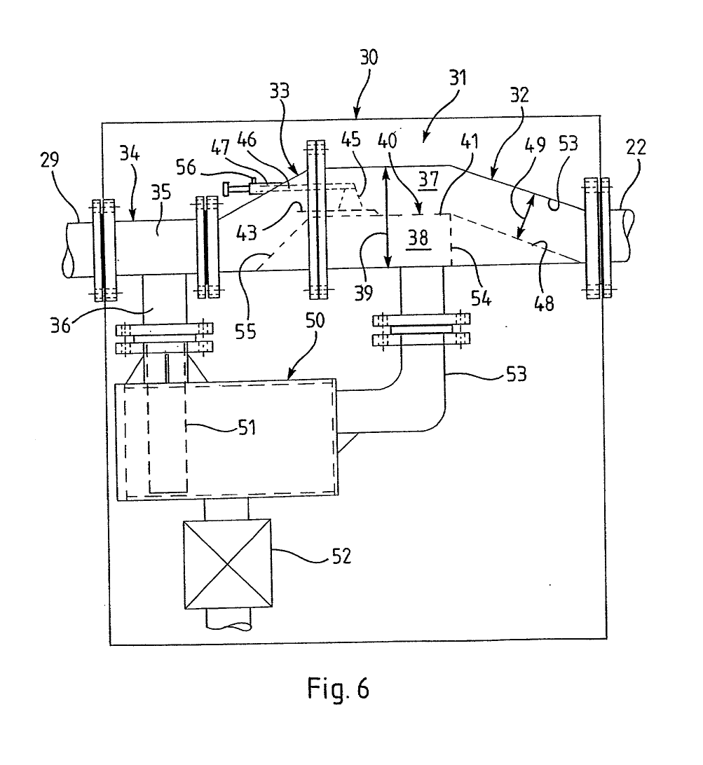

FIGS. 5 and 6 are views analogous to FIG. 2 and each show one variant of the sorter.

FIG. 1 shows diagrammatically a heat exchanger 10, for example a heat exchanger forming a condenser through which, as symbolized by the arrows F1, passes a flow of cooling fluid, in this instance water, via, on the one hand, an inlet pipe 11 and, on the other hand, an outlet pipe 12.

This kind of heat exchanger 10 is well known to the person skilled in the art and is not in itself relevant to the present invention, and for these reasons is not described here.

In practice it is a tubular heat exchanger, for example of the kind succinctly described in the document FR-A-2 716 530 mentioned above.

In the embodiment shown, filter means 13 are fitted to the inlet pipe 11 by means of a sleeve 14.

The filter means 13, which are not essential, are not relevant to the present invention either, and are not described here either. For example, they are filter means of the kind described in the document FR-A-2 609 644.

In a manner that is also known to the person skilled in the art, solid cleaning bodies can be circulated continuously in the heat exchanger 10 to clean it continuously.

In practice they are foam rubber balls whose diameter is slightly greater than that of the tubes of the heat exchanger 10 and whose density, when impregnated, is similar to that of water.

These solid cleaning bodies must be processed, i.e. not only circulated efficiently in the heat exchanger 10 but also monitored in terms of their number and dimensions.

In a manner that is known to the person skilled in the art, the solid cleaning bodies are systematically injected into the inlet pipe 11 downstream of the filter means 13 and are entrained by the incoming flow.

In a manner that is also known to the person skilled in the art, interceptor means 16 adapted to retain the circulating solid cleaning bodies are fitted to the outlet pipe 12, by means of a sleeve 15, and a control installation 17, described in more detail later, recycles the solid cleaning bodies retained by the interceptor means 16 to the inlet pipe 11.

The interceptor means 16 are not described in detail here because they are not in themselves relevant to the present invention.

Suffice to say that they include V-shaped grids 18 that block the sleeve 15 transversely, with the exception of an inter-grid gap 21, and which can be rotated about their axis 19 by actuator means 20.

The control installation 17 includes circulation means which are adapted to generate a localized flow from the inter-grid gap 21 toward the inlet pipe 11 and which themselves include, to this end, on the one hand, an inlet pipe 22 upstream of the interceptor means 16 and, on the other hand, a return pipe 23 which recycles to the inlet pipe 11 of the heat exchanger 10 a return flow containing the solid cleaning bodies retained by the interceptor means 16, and on which is installed a device for processing the solid cleaning bodies with a view to eliminating those whose dimensions are no longer sufficient, among other things.

In the embodiment shown, there is a pump 25 on the return pipe; the pivoted grids 18 can occupy at least two extreme positions, namely a “cleaning” position shown in full line in the figure, and in which they direct the cleaning bodies toward the inlet pipe 22 and the control device, and a “no cleaning” position, represented in dashed line in the figure.

In service, the solid cleaning bodies therefore pass continuously through the heat exchanger 10 and, retained by the interceptor means 16 at the outlet thereof, are aspirated by the pump 25 and recycled via nozzles 24, after passing through the control installation, which processes them.

In the example shown, the control installation 17 includes a counter 27 and a collector 28 in series between the discharge pipe 26 of the pump 25 and the return pipe 23.

A sorter 30 is provided between the inlet pipe 22 and the aspiration pipe 29 of the pump 25.

The sorter 30, which can be seen better in FIG. 2, includes a body 31 in two portions, namely a first portion 32 connected, on one side, to the inlet pipe 22 and, on the other side, to the second portion 33, which is in turn connected to the head 35 of a return Tee 34 connected to the aspiration pipe 29 of the pump 25.

Globally, the pipe 29 and the head 35 of the return Tee 34 have equal if not similar sections and the pipe 22 has a larger section than both of them.

Two compartments are formed within the body 31, namely a main compartment 37 between the inlet pipe 22 and the head 35 of the return Tee 34 and a recovery compartment 38, the two compartments 37 and 38 being separated by a calibrated grid 40, and turbulence generator means being provided to create turbulence in the compartment 38 to attract into the compartment 38 balls which can pass through the grid 40 because of their diameter.

The grid 40 is advantageously adjustable, so that balls of a chosen (i.e. variable) diameter can pass through it; to this end, the grid 40 includes a fixed portion 41, which can be seen in FIG. 4, having a series of globally aligned divergent slots 42, in this instance seven slots 42, which slots are therefore in the S shape of an isosceles trapezium, with the longer base on the same side as the aspiration pipe 29 and the shorter base on the same side as the inlet pipe 22, the grid 40 extending virtually parallel to the general direction of flow of the fluid between these pipes.

A mobile mask 43 (FIG. 3) covers the fixed portion 41 to a greater or lesser extent; it has teeth 44 at the front, each of said teeth 44 being adapted to cooperate with a slot 42; obviously, the closer the mobile mask 43 to the same end of the fixed portion 41 as the shorter bases of the trapezoidal slots 42, the smaller the ball sorting diameter.

For adjusting the position of the mobile mask 43, the latter carries a dorsal bracket 45 fastened to a rod 46 mounted to move in translation and in a sealed manner in a sheath 47 fixed axially; of course, by moving the rod 46, the mobile mask 43 is moved parallel to the fixed portion 41 of the grid 40; the rod for adjusting the position of the mobile mask 43 advantageously carries graduations visible in front of the sheath 47 and corresponding to the diameter set for the balls to be sorted; a screw 56 holds the rod 46 in the chosen position relative to the sheath 47.

The recovery compartment 38 is connected by a pipe 53 to the leg 36 of the return Tee 34 via a worn ball pot 50 to the inside of which the leg 36 of the return Tee 34 is connected via a strainer 51; a drain valve 52 removes worn balls from the pot 50.

It will have been noted that increasing the worn ball sorting diameter, i.e. moving the mobile mask 43 toward the left in FIG. 2, increases the passage surface area of the slots 42 and therefore the flowrate through the grid 40; thus the rate of passage through the grid is virtually constant, independently of the worn ball sorting diameter.

Note also that, because the width of the slots 42 of the grid 40 increases from right to left in FIGS. 2 and 4, i.e. because the balls move in the direction of the flow of fluid, the balls cannot become jammed in a slot 42 of the grid 40.

In the example shown, the turbulence generator means consist of an obstacle in the fluid flow section.

To be more precise, the first portion 32 of the body 31 has a section 39 divided longitudinally by the grid 40, which delimits the compartments 37 and 38 therein, and the grid 40 is preceded by a flow deflector 48.

The pipe 53 is connected to the recovery compartment side of the grid 40.

This creates turbulence in the recovery compartment 38, which causes worn balls passing over the grid 40 whose diameter is such that they can pass through the slots 42 to be directed toward this compartment.

The recovery compartment 38 is bordered on the same side as the inlet pipe 22 by a transverse wall 54 connected at the end to the flow deflector 48, but this wall is not indispensable and, as an alternative to this, the flow deflector 48 delimits the recovery compartment 38 at the same end as the inlet pipe 22.

On the same side as the return Tee 34, the recovery compartment 38 is bordered by an inclined partition 55 in the second portion 33 of the body 31 which, in combination with the latter, connects the main compartment 37 to the head 35 of the return Tee 34.

In the embodiment shown in FIG. 5, the turbulence generator means consist of an increase in the flow section.

Here the section 39 of the first portion 32 of the body 31 is large compared to the smaller section 49 of the inlet pipe 22.

In the example shown in FIG. 6, -the turbulence generator means consist of an increase in the fluid flow section and in the presence of an obstacle.

To be more precise, the first portion 32 of the body 31 includes the large section chamber 39 divided longitudinally by the grid 40, which delimits the compartments 37 and 38 therein, this chamber being preceded by a smaller section area 49 with approximately the same section as the inlet pipe 22; the small section chamber 49 is defined by the flow deflector 48 in combination with the top wall 53 of the first portion 32.

The pipe 53 is connected to the same side of the recovery chamber 38 as the large section chamber 39.

In the example shown in FIG. 1, the sorter 30 is upstream of the pump 25; of course, it can be placed elsewhere in the installation, for example between the pump 25 and the collector 28, and thus in the vicinity of the counter 27, or in a branch connection from the main line.

There is claimed:

1. A control installation for solid cleaning bodies adapted to be circulated in a heat exchanger to clean it, said installation including interceptor means in an outlet pipe of said heat exchanger adapted to retain the circulating solid cleaning bodies, a return pipe which recycles to an inlet pipe of said heat exchanger a return flow containing solid cleaning bodies retained by said interceptor means, and a system in said return pipe for processing said solid cleaning bodies and including a sorter which includes a body, in which there are two compartments separated by a calibrated grid, and turbulence generator means adapted to create turbulence in one compartment to attract into it cleaning bodies which can pass through said grid because of their diameter.

2. The control installation claimed in claim 1, further including circulation means which include an inlet pipe downstream of said interceptor means and a pump, said sorter being between said inlet pipe and an aspiration pipe of the pump.

3. The control installation claimed in claim 2, wherein said sorter has a body in two portions, namely a first portion connected, on one side, to said inlet pipe and, on the other side, to a second portion, which is itself connected to a head of a return Tee also connected to said aspiration pipe of said pump.

4. The control installation claimed in claim 3, wherein said two compartments of said body comprise a main compartment between said inlet pipe and said head of said return Tee and a recovery compartment in which turbulence is created.

5. The control installation claimed in claim 4, wherein said recovery compartment is connected by a pipe to a leg of said return Tee via a pot to the interior of which said leg of said return Tee is connected via a strainer.

6. The control installation claimed in claim 5, wherein said pot is connected to the exterior via a drain valve.

7. The control installation claimed in claim 1, wherein said grid has a fixed portion featuring a series of divergent slots and a mobile mask provided with teeth adapted to cooperate with said slots.

8. The control installation claimed in claim 7, wherein said grid is globally parallel to the direction of the flow through said body and the width of said slots is greater on the downstream side than on the upstream side relative to said flow.

9. The control installation claimed in claim 1, wherein said turbulence generator means consist of an increase in the section of the flow passage.

10. The control installation claimed in claim 9, wherein said body includes a large section chamber divided by said grid and preceded by a smaller section area.

11. The control installation claimed in claim 1, wherein said turbulence generator means consist of an obstacle in the flow passage.

12. The control installation claimed in claim 11, wherein said recovery compartment is bordered on the same side as said inlet pipe by a transverse wall constituting said turbulence generator means.

13. The control installation claimed in claim 11, wherein said recovery compartment is bordered on the same side as said inlet pipe by a flow deflector constituting said turbulence generator means.

14. The control installation claimed in claim 4, wherein said recovery compartment is bordered on the same side as said return Tee by a partition which connects said main compartment to said head of said return Tee.

15. A sorter for use in a control installation as claimed in any of claims 1 to 14, including two compartments separated by a grid and turbulence generator means.

16. The control installation sorter claimed in claim 15, wherein said turbulence generator means consist of an increase in the section of the flow passage.

17. The control installation claimed in claim 15, wherein said turbulence generator means consist of an obstacle in the flow passage.
